(19) United States
(12) Patent Application Publication
(10) Pub. No.: US 2016/0288278 A1
(43) Pub. Date: Oct. 6, 2016

(54) HEAT EXCHANGER ASSEMBLY PROCESS AND SYSTEM

(71) Applicant: Caterpillar Inc., Peoria, IL (US)

(72) Inventors: Daniel Thomas Cavanaugh, Chillicothe, IL (US); Derek Leonard Waldschmidt, Peoria, IL (US)

(73) Assignee: Caterpillar Inc., Peoria, IL (US)

(21) Appl. No.: 14/679,287

(22) Filed: Apr. 6, 2015

(51) Int. Cl. B23P 15/26

(52) U.S. Cl. CPC B23P 15/26

(57) ABSTRACT

A heat exchanger assembly process and system are disclosed. The assembly method may include positioning a core for assembly, the core having a plurality of tubes. The method may also include pressurizing the core by increasing the pressure of a fluid within each of the plurality of tubes to a threshold pressure. The method may further include moving the pressurised core into an interior space of a housing.

### TECHNICAL FIELD

The present disclosure relates generally to a heat exchanger and, more particularly, to a heat exchanger assembly process and system.

### BACKGROUND

Machines including, for example, earth moving vehicles, passenger vehicles, and generators, utilize one or more heat exchangers during operation. Heat exchangers may be used to modify or maintain the temperature of fluids circulated throughout the machines. For example, an internal combustion engine is generally fluidly connected to several different liquid-to-liquid, liquid-to-air, and/or air-to-air heat exchangers (e.g., oil cooler, radiator, air cooler) to cool liquids and gases circulated throughout the engine. The circulated fluids may include oil, coolant, water, exhaust gas, air, or other fluids used in various machine operations.

In general, heat exchangers transfer thermal energy between two fluids without direct contact between the two fluids. A first fluid is typically directed through a fluid conduit of the heat exchanger, while a second fluid is brought into external contact with the fluid conduit, in this manner, thermal energy may be transferred between the first and second fluids through the walls of the fluid conduit. One such heat exchanger (e.g., an oil cooler device) includes a bundle of tubes enclosed within an outer shell: A first fluid flows through the bundle of tubes, while a second fluid flows outside of the bundle of tubes within the outer shell. Heat transfer between the first and second fluids occurs through the walls of the tubes.

While this type of heat exchanger can be effective at transferring thermal energy, there are potential problems. For example, it is difficult to precisely position each tube at a desired location during assembly of the heat exchanger. In particular, during assembly, the bundle of tubes may flex due to the length of the tubes and shell, as well as the small tolerance therebetween. When this flexure occurs, the tubes may bend, changing the spacing between the tubes. This is a potential problem because the effectiveness of the heat. exchanger may depend on the plurality of tubes being precisely positioned within the outer shell such that the fluid that flows on an outside of the tubes is substantially evenly distributed across all of the plurality of tubes. Also, vibration that occurs during machine operation may cause the tubes that are out of place to rub against a surface (e.g., another tube, the shell, or other component), which may cause the tube to wear and eventually fail.

One attempt to address a similar problem is disclosed in U.S. Pat. No. 4,264,304, which issued to Hayes on Nov. 25, 1986 (“the '304 patent”). In particular, the '304 patent discloses a shell and tube type heat exchanger that includes tube spacers and support members to help prevent the tubes from contacting each other due to vibration. The spacers and support members themselves are susceptible to vibration, so the '304 patent further discloses a method of locking the support members in place. In particular, the '304 patent discloses a method in which flattened tubes are inserted between each layer of tubes and then pressurized to expand and lock the support members in place.

While the method disclosed by the '304 patent may help prevent damage to the types of vapor generators disclosed in the reference, it is limited in its application. For example, the method of the '304 patent only helps to place specific types of support members in place, which are not present in many heat exchangers. Further, the method does not help to position the tubes correctly during placement of the tubes into the shell, instead requiring a separate process that takes place after assembly.

The present disclosure is directed at overcoming one or more of the shortcomings set forth above and/or other problems of the prior art.

### SUMMARY OF THE DISCLOSURE

In one aspect, the present disclosure is directed to a method of assembling a heat exchanger. The method may include positioning a core for assembly, the core including a plurality of tubes. The method may also include pressurizing the core by increasing the pressure of a fluid within each of the plurality of tubes to a threshold pressure. The method may further include moving the pressurized core into an interior space of a housing.

in another aspect, the present disclosure is directed to another method of assembling a heat exchanger. The method may include positioning a core for assembly, the core including a plurality of tubes. The method may also include partially inserting the core into an interior space of a housing. The method may further include temporarily sealing open ends of the plurality of tubes and pressurizing the core by increasing the pressure of a fluid within each of the plurality of tubes to a threshold pressure. The method may additionally include moving the pressurized core further into the interior space of a housing.

in yet another aspect, the present disclosure is directed to a pressurization system for assembling a heat exchanger. The heat exchanger may include a core comprising a plurality of tubes and a housing. The pressurization system may include a pressure connection configured to be connected to first open ends of the plurality of tubes and temporarily seal the first open ends. The pressure connection may include an inlet and a plurality of projections each including an outlet. The pressurization system may also include a sealing member configured to frictionally engage an inner surface of the housing and temporarily seal second open ends of the plurality of tube. The pressure connection may be configured to pressurize the core by increasing the pressure of a fluid within each of the plurality of tubes to a threshold pressure.

### BRIEF DESCRIPTION OF THE DRAWINGS

FIG. 1 is a cross-sectional illustration of an exemplary disclosed heat exchanger;

FIG. 2 is a cross-sectional illustration of an exemplary pressurization system configured to be used in conjunction with the assembly of the heat exchanger of FIG. 1; and

FIG. 3 is a cross-sectional illustration of a method for assembling the heat exchanger of FIG. 2.

### DETAILED DESCRIPTION

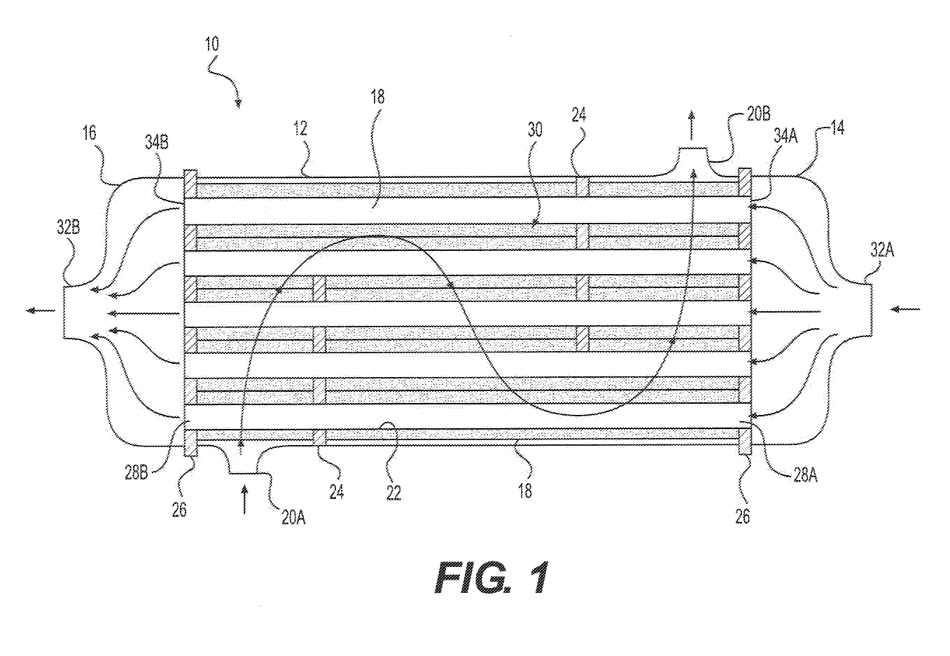

FIG. 1 illustrates a heat exchanger 10. Heat exchanger 10 may be a shell and tube heat exchanger, a heat pipe heat exchanger, or any other tube-type heat exchanger that facilitates transfer of thermal energy between two or more fluids and includes a tube within a housing or shell. The fluids may include liquids, gasses, or any combination of liquids and gasses. For example, the fluids may include air, exhaust, oil, coolant, water, or any other fluid known in the art. Heat exchanger 10 may be used to transfer thermal energy in any type of fluid system, such as, for example, an oil cooling system, an exhaust and/or air cooling system, a radiator system, a condenser system, or any other type of fluid system known in the art. Heat exchanger 10 may include a housing 12, a first manifold 14, a second manifold 16, and a plurality of tubes 18.

Housing 12 may be a hollow member forming an outer shell of heat exchanger 10. Housing 12 may be configured to conduct fluid around an exterior of tubes 18. For example, housing 12 may have an inlet 20A configured to receive a first fluid and an outlet 20B configured to discharge the first fluid. Housing 12 may further include an interior space 22 formed between open ends of housing 12. for receiving tubes 18. One or more baffles 24 and one or more support members 26 may also be located within interior space 22.

Tubes 18 may be elongated members that conduct a second fluid through each tube 18 and promote the transfer of thermal energy between the first and second fluids. Tubes 18 may include a first open end 28A and a second open end 23B and may be manufactured of any metal, such as, for example, copper, aluminum, steel, or any other metal known in the art. Tubes 18 may have any cross-sectional shape, such as, for example, a circular shape, an elliptical shape, or a rectangular shape. It is contemplated that tubes 18 may include turbulence promoting or enhancing structures (e.g., turbulators) located on an interior surface of tubes 18. These turbulence promoting structures may comprise ridges, fins, angled strips, pins, or other types of protrusions or distortions

Baffles 24 may be configured to redirect the first fluid as it travels through interior space 22. and around tubes 18. The redirection of the first fluid may help increase the transfer of heat by increasing the first fluid's interaction with tubes 18 (i.e., preventing a direct flow path from inlet 20A to outlet 20B) and/or directing the first fluid to flow in a direction approximately normal to a flow direction of the second fluid within tubes 18 (i.e., creating a cross flow configuration). It is contemplated that baffles 24 may also be rearranged to create a parallel flow or counter flow configuration.

Support members 26 may embody plate-like members that include a plurality of holes configured to receive and support tubes 18. Support members 26 may couple to tubes 18 via mechanical fastening, chemical bonding, welding, or in any other appropriate manner. It is contemplated that support members 26 may be manufactured of a rubber-based material that supports and seals to each end of tubes 18. Support members 26 may alternatively be manufactured of metal, plastic, composite, or any other material known in the art.

In an exemplary embodiment, baffles 24 and/or support members 26 may be coupled to tubes 18 to form a core 30. Core 30 may include the plurality of tubes 18, baffles 24, and support members 26 as an interconnected assembly or module such that core 30 may be assembled outside of housing 12 and then inserted as one piece into housing 12 during assembly of heat exchanger 10. In this way, each of the plurality of tubes 18 may be inserted into the housing 12 at the same time. An outer perimeter of core 30 may approximately equal to an inner perimeter of housing 12 such that core 30 is frictionally held in place within interior space 22.

First and second manifolds 14 and 16 may be hollow members that distribute the second fluid to or gather the second fluid from a tube 18. First manifold 14 may have a first orifice 32A, and a plurality of second orifices 34A fluidly connected to first open ends 28A of a plurality of tubes 18. Second manifold 16 may have a first orifice 32B and a plurality of second orifices 34B fluidly connected to second open ends 28B of tubes 18. It is contemplated that first orifice 32A of first manifold 14 and/or first orifice 32B of second manifold 16 may be fluidly connected to a fluid system component (not shown), such as, for example, a filter, a pump, a nozzle, a power source, or any other fluid system component known in the art. It is contemplated that the second fluid may flow through first manifold 14 and second manifold 16 in either direction (i.e., the second fluid may enter first manifold 14 and exit second manifold 16 or enter second manifold 16 and exit first manifold 14).

Heat exchanger 10 may be assembled by moving core 30 into interior space 22 through an open end of housing 12 and then connecting first manifold 14 and second manifold 16 to opposite ends of housing 12 and tubes 18. For example, assembly may include axially sliding core 30 into interior space 22. In some embodiments, a pressing machine (not shown), such as a hydraulic or pneumatic press, may be used to press core 30 into interior space 22. In this way, an interference fit between core 30 and housing 12 may be achieved, helping to maintain core 30 in place within interior space 22.

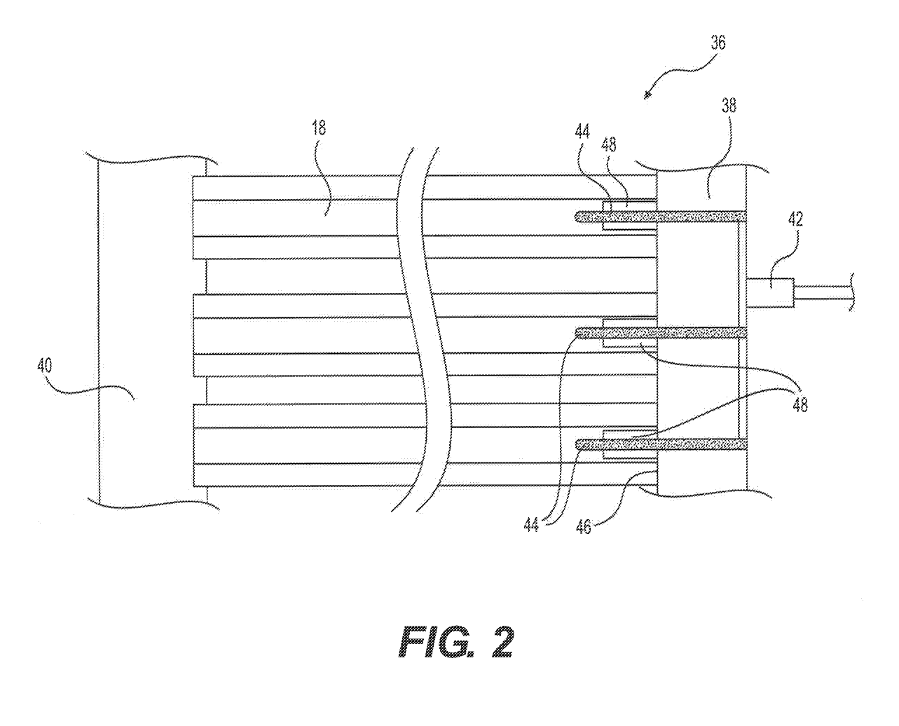

However, simply sliding and/or pressing core 30 into interior space 22 may allow one or more of tubes 18 to bend or kink during assembly. FIG. 2 depicts a pressurization system 36 that may help inhibit this problem by pressurizing tubes 18 prior to being moved into interior space 22. In an exemplary embodiment, pressurization system 36 may include a pressure connection 38 and a sealing member 40.

Pressure connection 38 may be a component configured to deliver a fluid to one or more of tubes 18. The fluid may be any fluid, such as water or air. In an exemplary embodiment, pressure connection 38 may include an inlet 42 and a plurality of outlets 44. Inlet 42 may be connected to a fluid source (e.g., a pressurized tank) and be configured to deliver the fluid to tubes 18 via outlets 44. In some embodiments, pressure connection 38 may include a regulator and/or sensor system configured to control an amount of fluid that is delivered to tubes 18.

Pressure connection 38 may include an interface 46 that sealingly engages the first open ends 28A of tubes 18. Interface 46 may be formed from a material, such as a hard rubber, that provides a tight seal and inhibits leakage. In some embodiments, pressure connection 38 may include a plurality of projections 48 at interface 46, each projection 48 including an outlet 44. Each projection 48 may be configured to fit within a first open end 28A of tubes 18. Projections 48 may assist with the connection of pressure connection 38 to tubes 18 by guiding engagement therewith. In some embodiments, pressure connection 38 may include a connection member (not shown), such as a clamp or temporary adhesive that helps to hold pressure connection 38 tightly to core 30.

Sealing member 40 may be a component that closes off second open ends 28B of tubes 18. For example, sealing member 40 may be a rubber block that is held in place against the second open ends 28B of tubes 18 to sealingly engage therewith. It should be understood, however, that other materials and configurations for sealing member 40 are possible. For example, sealing member may include one or more plugs that are inserted into and seal the second open ends 28B of one or more corresponding tubes 18.

In some embodiments, sealing member 40 and housing 12 may be configured such that sealing member 40 frictionally engages an inner surface of housing 12 when sealing member 40 is positioned in interior space 22. In this way, when core 30 is moved through interior space 22, tubes 18 may push sealing member 40 through interior space 22, causing sealing member 40 to frictionally slide against the inner surface of housing 12. This frictional engagement may help to keep sealing member 40 in contact with second open ends 28B of tubes 18, thereby creating a tight seal.

As shown in FIG. 2, pressure connection 38 and sealing member 40 may be connected to tubes 18 such that tubes 18 are sealed from the atmosphere. This arrangement allows pressure connection 38 to direct a fluid into tubes 18, and allows the pressure of the fluid to increase within each of the plurality of tubes. A control system (not shown) may be configured to control pressure connection 38 and/or a connected fluid tank such that tubes 18 may be pressurized to a threshold pressure. The threshold pressure may be, for example, a pressure that causes a desired effect on tubes 18. For example, the threshold pressure may be a sufficient pressure to achieve desired strength and rigidity characteristics of tube 18 and/or core 30, such that bending of tubes 18 is substantially inhibited when core 30 is inserted into housing 12, as described in more detail below.

### INDUSTRIAL APPLICABILITY

The disclosed assembly process and pressurization system may be applicable to the assembly of any component that includes an elongated tube that is inserted into another member. In particular, the disclosed assembly process and pressurization system may be particularly applicable to heat exchangers, such as shell and tube type heat exchangers. The disclosed pressurization system may allow for pressurization of one or more tubes before being inserted into another member (e.g., a housing), which may increase the strength and rigidity of the tube(s). The increased strength and rigidity may inhibit undesirable bending of one or more tubes while they are being moved into the housing, thus increasing the efficiency and reliability of the heat exchanger.

The exemplary disclosed assembly process may be used to assemble a new heat exchanger (e.g., using unused parts) or a remanufactured heat exchanger, such as a heat exchanger in which a new core is inserted into a used housing. Operation of heat exchanger 10 and an exemplary process for assembling heat exchanger 10 are described in more detail below.

Referring to FIG. 1, heat exchanger 10 may be utilized, for example, to transfer thermal energy between a lower temperature first fluid flowing through housing 12 and a higher temperature second fluid flowing through tubes 18. The lower temperature first fluid may be received into housing 12 via inlet 20A. The first fluid may then be directed by baffles 24 to flow in a switchback-like pattern past tubes 18. The switchback-like pattern may increase the percentage of the total flow path where the first fluid is flowing in a direction generally normal to the flow direction of the second fluid.

While the first fluid flows through housing 12, first manifold 14 may receive the higher temperature second fluid and may distribute the second fluid into the inlet ends of tubes 18. After entering tubes 18, the second fluid may be conducted through the length of each of tubes 18. As the second fluid flows through each of tubes 18, the thermal energy from the higher temperature second fluid may be conducted through tubes 18 into the lower temperature first fluid. As the thermal energy is transferred from the second fluid to the first fluid, the temperature of the second fluid will decrease.

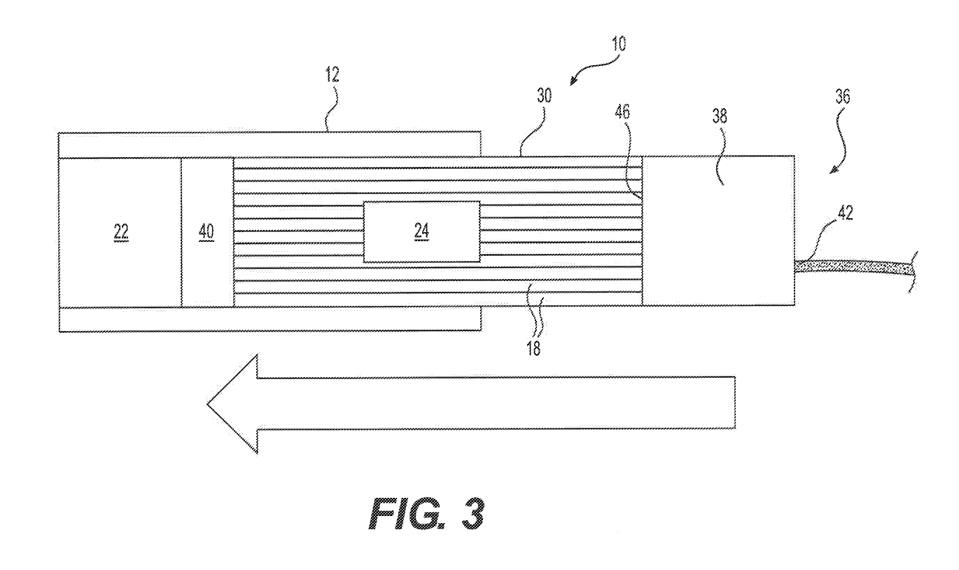

FIG. 3 further depicts heat exchanger 10 and pressurization system 36 during an exemplary heat exchanger assembly process. In particular, FIG. 3 depicts heat exchanger while core 30 is being moved into the interior space 22 of housing 12. In order to reach the state of FIG. 3, the assembly process may include positioning core 30 for assembly. For example, core 30 may be placed in a position that is suitable for assembling heat exchanger 10 (e.g., adjacent a pressing machine). The assembly process may further include temporarily sealing open ends 28A, 28B of tubes 18. For example, pressure connection 38 may be connected to first open ends 28A of tubes 18. In one example, projections 48 may be inserted into corresponding first open ends of tubes 18.

Further, sealing member 40 may be connected to second open ends 28B of tubes 18. In one example, sealing member 40 may be positioned inside interior space 22, near an open end of housing 12. Core 30 may be partially inserted into the open end of housing 12 and moved until core 30 comes into contact with sealing member 40. In other embodiments, sealing member 40 may be connected to core 30 prior to being inserted into housing 12.

After tubes 18 are sealed to the atmosphere, pressurization system 36 may pressurize the core 30 by directing fluid from a tank, through pressure connection 38 (into inlet 42 and out of outlets 44), and into tubes 18. Pressurization system 36 may pressurize core 30 until a pressure of the fluid in the tubes 18 reaches a threshold pressure. For example, pressurization system 36 may direct a predetermined amount of fluid into core 38, or pressurization system 36 may monitor the pressure (e.g., via one or more sensors) to determine when the pressure reaches the threshold level.

Pressurized core 30 may thereafter be moved into interior space 22. For example, an operator and/or machine may insert core 30 into an open end of housing 12 and slide and/or press the pressurized core 30, including tubes 18, baffles 24, and support members 26, into housing 12, until the tubes 12 are fully inserted into housing 12. In the example in which core 30 is partially inserted into housing 12 prior to pressurization, this step may include moving pressurized core 30 further into interior space 22.

Once core 30 is in position, the first and second open ends 28A, 28B of tithes 18 may be unsealed and the fluid drained and/or allowed to escape. For example, pressure connection 38 may be disconnected from first open ends 28A and sealing member 40 may be moved away from second open ends 28B. In some instances, sealing member 40 may simply fall away from housing 12 once core 30 is fully inserted (e.g., be pushed out of interior space 22 once core 30 reaches the open end).

After core 30 is positioned in housing 12, first and second manifolds 14, 16 may be placed on a respective open end of housing 12 and fluidly connected to tubes 18. The resulting assembled heat exchanger 10 may be installed in or on a machine, such as an engine, and used during operation of the machine to transfer heat, as described above.

As described herein, the resulting heat exchanger 10 may be less susceptible to damage because of the use of pressurization system 36 during assembly. That is, because core 30 was pressurized during assembly, undesirable bending of tubes 18 during assembly was inhibited. In this way, a desired spacing between tubes 18 is maintained, promoting high efficiency operation of heat exchanger 10. In addition, vibrations of tubes 18 caused by operation of the machine are less likely to cause damage to heat exchanger 10.

It will be apparent to those skilled in the art that various modifications and variations can be made to the disclosed heat exchanger assembly process and system. Other embodiments will be apparent to those skilled in the art from consideration of the specification and practice of the disclosed heat exchanger exchanger and system, it is intended that the specification and examples be considered as exemplary only, with a true scope being indicated by the following claims and their equivalents.

What is claimed is:

1. A method of assembling a heat exchanger, comprising:
positioning a core for assembly, the core comprising a plurality of tubes;
pressurizing the core by increasing the pressure of a fluid within each of the plurality of tubes to a threshold pressure; and
moving the pressurized core into an interior space of a housing.

2. The method of claim 1, further comprising temporarily sealing open ends of the plurality of tubes prior to pressurizing.

3. The method of claim 2, wherein temporarily sealing the open ends of the plurality of tubes includes connecting a pressure connection to first open ends of the plurality of tubes.

4. The method of claim 3, wherein pressurizing the core includes directing fluid into the plurality of tubes through the pressure connection.

5. The method of claim 4, wherein:
the pressure connection includes an inlet and a plurality of outlets; and
filling the plurality of tubes includes directing the fluid into the inlet and out of the plurality of outlets, and into a corresponding tube of the plurality of tubes.

6. The method of claim 5, wherein:
the sealing member includes a plurality of projections, each projection including an outlet of the plurality of outlets, and
connecting the pressure connection to the first open ends of the plurality of tubes includes inserting each of the plurality of projections into the first open end of the corresponding tube.

7. The method of claim 2, wherein temporarily sealing the open ends of the plurality of tubes includes connecting a sealing member to second open ends of the plurality of tubes.

8. The method of claim 7, wherein connecting the sealing member to the second open ends of the plurality of tubes includes placing the sealing member against the second open ends of the plurality tubes within the interior space of the housing.

9. The method of claim 1, wherein moving the pressurized core into the interior space of the housing includes axially sliding the pressurized core into the interior space.

10. The method of claim 9, wherein moving the pressurized core into the interior space of the housing includes pressing the pressurized core into the interior space using a pressing machine.

11. The method of claim 2, further including unsealing the open ends of the plurality of tubes and placing a pair of manifolds on respective open ends of the housing.

12. The method of claim 1, wherein the fluid is water.

13. The method of claim 1, wherein the fluid is air.

14. A method of assembling a heat exchanger, comprising:
positioning a core for assembly, the core comprising a plurality of tubes;
partially inserting the core into an interior space of a housing;
temporarily sealing open ends of the plurality of tubes;
pressurizing the core by increasing the pressure of a fluid within each of the plurality of tubes to a threshold pressure; and
moving the pressurized core further into the interior space of a housing.

15. The method of claim 14, wherein temporarily sealing the open ends of the plurality of tubes includes connecting a pressure connection to first open ends of the plurality of tubes.

16. The method of claim 14, wherein temporarily sealing the open ends of the plurality of tubes includes positioning a sealing member inside the interior space of the housing such the sealing member contacts the second open ends of the plurality of tubes after the core is partially inserted into the interior space of the housing.

17. The method of claim 16 wherein the sealing member and the housing are configured such that the sealing member frictionally engages an inner surface of the housing when it is positioned inside the interior space.

18. The method of claim 17, wherein moving the pressurized core further into the interior space of the housing includes frictionally sliding the sealing member against the inner surface of the housing.

19. The method of claim 14, further including unsealing the open ends of the plurality of tubes and placing a pair of manifolds on respective open ends of the housing.

20. A pressurization system for assembling a heat exchanger, the heat exchanger including a core comprising a plurality of tubes and a housing, the system comprising:
a pressure connection configured to be connected to first open ends of the plurality of tubes and temporarily seal the first open ends, the pressure connection including an inlet and a plurality of projections each including an outlet; and
a sealing member configured to frictionally engage an inner surface of the housing and temporarily seal second open ends of the plurality of tubes;
wherein the pressure connection is configured to pressurize the core by increasing the pressure of a fluid within each of the plurality of tubes to a threshold pressure.
